(19) United States
(12) Patent Application Publication
(10) Pub. No.: US 2015/0349540 A1
(43) Pub. Date: Dec. 3, 2015

(54) APPARATUS AND METHOD FOR TRANSMITTING WIRELESS POWER

(71) Applicant: Hyundai Motor Company, Seoul (KR)

(72) Inventor: Hee Jin Lee, Daegu (KR)

(21) Appl. No.: 14/533,680

(22) Filed: Nov. 5, 2014

(30) Foreign Application Priority Data
Jun. 3, 2014 (KR) 10-2014-0067703

(51) Int. Cl. H02J 5/00

(52) U.S. Cl. CPC H02J 5/005

(57) ABSTRACT

A wireless power transmission apparatus includes: a transmitter to generate transmission power to a receiving coil of a receiving device through a transmitting coil, a location adjuster to adjust a location of the transmitter based on a location of the receiving coil, a voltage ratio calculator to calculate a voltage ratio applied to the receiving coil according to a location variation of the transmitter, and a transmission power determiner to determine an intensity of the transmission power for a signal output to the receiving device resulting from the voltage ratio applied to the receiving coil, and to transmit a signal corresponding to the intensity of the transmission power to the transmitter.

### CROSS-REFERENCE TO RELATED APPLICATION

This application claims the benefit of and priority to Korean Patent Application No. 10-2014-0067703, filed on Jun. 3, 2014 in the Korean Intellectual Property Office, the disclosure of which is incorporated herein in its entirety by reference.

### BACKGROUND

1. Technical Field

The present disclosure relates to an apparatus and a method for transmitting wireless power, and more particularly, to a technology that determines a transmission power corresponding to a receiving device while varying a location of transmitting coil.

2. Description of the Related Art

A transmission device may be provided with an internal coil that generates a transmission power. In this case, when mutual inductance of the coil exceeds a certain amount, frequency splitting occurs between a transmission device and the receiving device, whereas, when the mutual inductance is less than a certain amount, a transmitting efficiency may be reduced. Accordingly, when manufacturing the transmission device, the coil may be fixed to a specific location so that the mutual inductance between the coil and the receiving device may not exceed a certain amount of mutual inductance.

Currently existing transmission devices for wireless power transmission may be mostly set to be a one-to-one correspondence with the receiving device. For example, a mobile phone charger as a transmission device may correspond to a mobile phone as a receiving device one-to-one, and a corresponding mobile phone charger is unable to charge other types of device. Thus, a single wireless power charger is not able to charge a plurality of devices, because a permitted amount of power may be previously set for each individual device, i.e., each receiving device, and the device cannot be operated when power less than a preset amount is transmitted, or durability may not be secured when power larger than a preset amount is transmitted.

Accordingly, because a transmission device and receiving device can be set to a one-to-one correspondence, the transmission device has no choice but to transmit a preset amount of power.

### SUMMARY

The present disclosure has been made in view of the above problems, and provides an apparatus and a method for transmitting wireless power that can determine power transmission corresponding to each receiving device by measuring rated power of a corresponding receiving device and by calculating a voltage ratio applied to a receiving coil of the receiving device while varying location of a transmitting coil.

In accordance with an aspect of the present disclosure, a wireless power transmission apparatus includes: a transmitter to generate transmission power to a receiving coil of a receiving device through a transmitting coil; a location adjuster to adjust a location of the transmitter based on a location of the receiving coil; a voltage ratio calculator to calculate a voltage ratio applied to the receiving coil according to a location variation of the transmitter; and a transmission power determiner to determine an intensity of the transmission power for a signal output to the receiving device resulting from the voltage ratio applied to the receiving coil, and transmit a signal corresponding to the intensity of the transmission power to the transmitter.

The voltage ratio calculator calculates a ratio of a forward voltage of the receiving coil and a reflect voltage based on a variation of mutual inductance of the transmitting coil according to the location variation of the transmitter. The transmission power determiner measures rated power of the receiving device in a location in which a difference between the forward voltage and the reflect voltage is minimized according to the location variation of the transmitter. The transmission power determiner determines the rated power of the receiving device as transmission power of the transmitting coil. The location adjuster adjusts the location of the transmitter by a predetermined distance unit based on at least one direction among front, rear, left, right, up, down, and diagonal directions. The location adjuster adjusts the location of the transmitter from a long distance to a short distance based on the location of the receiving coil.

In accordance with another aspect of the present disclosure, a wireless power transmission method includes: adjusting a location of a transmitting coil based on a location of a receiving coil for a receiving device; calculating a voltage ratio applied to the receiving coil according to a location variation of the transmitting coil; determining an intensity of transmission power for a signal output to the receiving device resulting from the voltage ratio applied to the receiving coil; and generating transmission power corresponding to the determined intensity of the transmission power from the transmitting coil to the receiving coil.

Calculating of the voltage ratio includes calculating a ratio of a forward voltage of the receiving coil and a reflect voltage based on variation of mutual inductance of the transmitting coil according to the location variation of the transmitting coil. The wireless power transmission method further includes measuring rated power of the receiving device in a location in which a difference between the forward voltage and the reflect voltage is minimized according to the location variation of the transmitting coil. Determining of the intensity of the transmission power includes determining the rated power of the receiving device as transmission power of the transmitting coil. Adjusting of the location of the transmitting coil includes adjusting the location of the transmitting coil by a predetermined distance unit based on at least one direction among front, rear, left, right, up, down, and diagonal directions. Adjusting the location of the transmitting coil includes adjusting the location of the transmitting coil from a long distance to a short distance based on the location of the receiving coil.

According to the present disclosure, it is possible to measure rated power of receiving device on the basis of a location in which a voltage ratio having the highest power efficiency is calculated based on a variation of voltage ratio according to a variation of location by calculating voltage ratio applied to receiving coil, while varying a location of transmitting coil, such that it is possible to determine power transmission corresponding to each receiving device, thereby easily transmitting transmission power to a different type of receiving device.

### BRIEF DESCRIPTION OF THE DRAWINGS

The objects, features and advantages of the present disclosure will be more apparent from the following detailed description in conjunction with the accompanying drawings, in which:

FIG. 1 is a diagram schematically illustrating a wireless power transmission apparatus according to an exemplary embodiment of the present disclosure;

FIG. 2 is a block diagram illustrating a configuration of a wireless power transmission apparatus according to an exemplary embodiment of the present disclosure;

FIG. 3 is a diagram illustrating an example of a configuration of a transmitter of wireless power transmission apparatus according to an exemplary embodiment of the present disclosure;

FIGS. 4A to 6 are diagrams illustrating an operation of wireless power transmission apparatus according to an exemplary embodiment of the present disclosure; and

FIG. 7 is a flowchart illustrating an operation flow of wireless power transmission method according to an exemplary embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

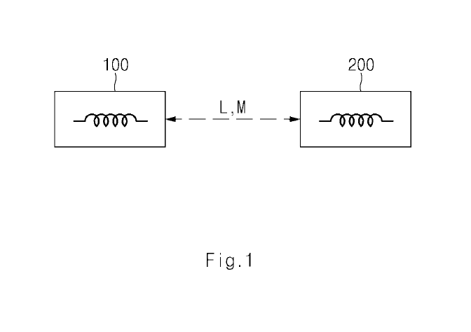

FIG. 1 is a diagram schematically illustrating a wireless power transmission apparatus according to an exemplary embodiment of the present disclosure.

Referring to FIG. 1, a wireless power transmission apparatus 100 (hereinafter, referred to as “apparatus”) according to an embodiment of the present disclosure may include a transmitting coil in the inside to generate transmission power determined based on a distance L between the apparatus 100 and a receiving device 200, and a voltage ratio M, or the like.

At this time, a receiving coil may also be provided in the inside of the receiving device 200, and, when a location of the transmitting coil inside of the apparatus 100 is varied, mutual induction between the transmitting coil and the receiving coil is varied. Thus, according to the location variation of the transmitting coil, a voltage ratio applied to the receiving coil of the receiving device 200, i.e., a ratio of forward voltage and reflect voltage is also varied. Here, the apparatus 100 may measure the rated power of the receiving device 200 on the basis of the voltage ratio applied to the receiving coil to determine transmission power for corresponding receiving device 200.

In this case, a different receiving device 200 may have different power efficiency with the apparatus 100 according to an internal specification. Accordingly, the present disclosure may determine the rated power of each receiving device 200 based on the voltage ratio of the receiving coil measured according to the location variation of the transmitting coil, and determine it as the transmission power of the transmitting coil, thereby enabling to transmit transmission power corresponding to each receiving device 200.

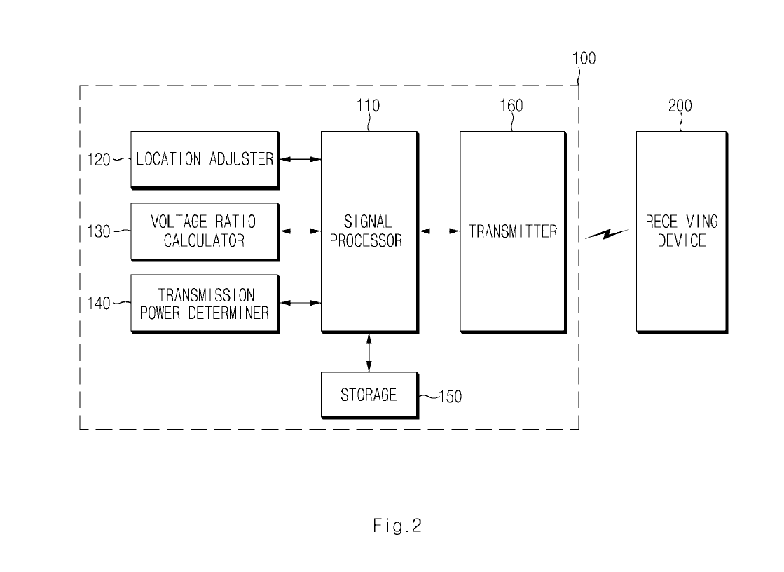

Thus, a detailed configuration of the apparatus 100 according to the present disclosure is described in more detail with reference to FIG. 2.

FIG. 2 is a block diagram illustrating a configuration of a wireless power transmission apparatus according to an embodiment of the present disclosure.

Referring to FIG. 2, the apparatus 100 according to the present disclosure may include a signal processor 110, a location adjuster 120, a voltage ratio calculator 130, a transmission power determiner 140, a storage 150, and a transmitter 160. Here, the signal processor 110 may process a signal transmitted between each unit of the apparatus 100.

The location adjuster 120 may adjust location of transmitter 160 based on location of receiving device 200. In detail, the location adjuster 120 may adjust location of transmitting coil of transmitter 160. Here, the location adjuster 120 may adjust the location of the transmitting coil to vary a distance between a transmitting coil and a receiving coil of receiving device 200.

At this time, the location adjuster 120 may adjust the location of transmitting coil by a predetermined distance unit based on at least one direction among front, rear, left, right, up, down, and diagonal directions. In this case, the location adjuster 120 may adjust the location of transmitting coil to vary with a predetermined distance unit from the farthest distance toward the receiving coil on a straight line connecting the transmitting coil and the receiving coil.

At this time, when a distance between the transmitting coil of apparatus 100 and the receiving coil of receiving device 200 varies, mutual induction between the coils may also be varied. Here, the mutual induction may vary in proportion to the distance.

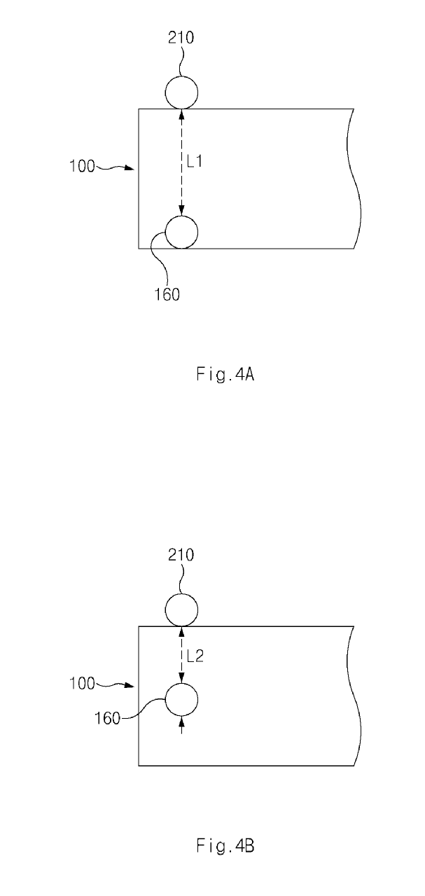

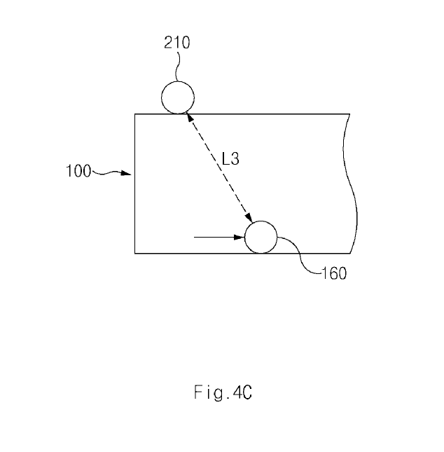

The embodiment of operation of varying the location of the transmitting coil by the location adjuster 120 will be illustrated with reference to FIGS. 4A to 4C.

When the location of the transmitting coil is varied by the location adjuster 120, the voltage ratio calculator 130 may calculate a voltage ratio applied to the receiving coil of receiving device 200 according to location variation of transmitting coil.

In this case, the voltage ratio calculator 130 may determine change of mutual induction of the transmitting coil according to location variation of transmitting coil, and calculate voltage ratio applied to receiving coil of receiving device 200 according to the change of determined mutual induction.

Here, the voltage ratio calculator 130 may calculate the ratio of forward voltage of transmitting coil to reflect voltage. In this case, in the outside of a certain distance, as the transmitting coil approaches the receiving coil, the difference of voltage ratio may be decreased, thereby power efficiency may be increased. However, when the transmit coil and the receiving coil get closer than a certain distance, the difference of voltage ratio may be increased again, and thus power efficiency may be decreased.

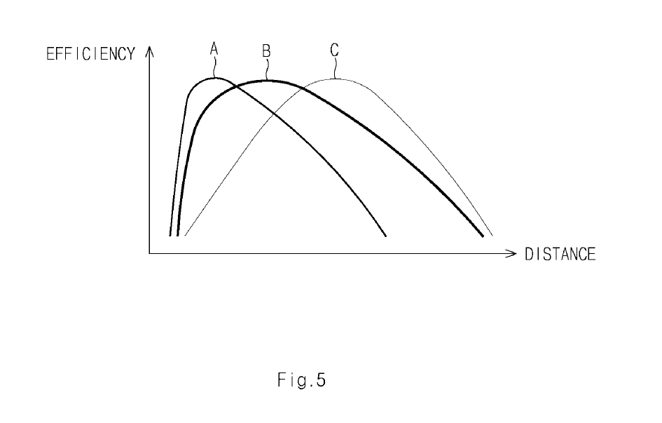

The embodiment of change of power efficiency according to distance change between the transmitting coil and the receiving coil will be described with reference to FIG. 5.

When the voltage ratio applied to the receiving coil according to location variation of transmitting coil is calculated from the voltage ratio calculator 130, the transmission power determiner 140 may determine an intensity of transmission power for receiving device 200 from the voltage ratio calculated according to location variation of transmitting coil.

At this time, the transmission power determiner 140 may measure the rated power of corresponding receiving device 200 in a location in which a difference between the forward voltage measured for receiving coil and the reflect voltage is minimized, and may determine an intensity of transmission power for a signal output to the receiving device 200 based on the measured rated power of the receiving device 200. Therefore, the transmission power determiner 140 may output a signal corresponding to the determined intensity of transmission power to the transmitter 160.

The storage 150 may store a setting value for an operation of wireless power transmission of apparatus. For example, the storage 150 may store information related to resonant frequency and Q-factor for the transmitting coil. The transmitter 160 may generate the transmission power to the receiving device 200 through the transmitting coil.

Here, the transmitter 160 may include a ferrite and a transmitting coil, and may further include a variable capacitor, for example. The transmitting coil may generate magnetism corresponding to the transmission power to reach a reception unit. The ferrite may serve to increase the inductance of the transmitting coil and may be implemented in a rod form, and may also be implemented in a sheet form according to an embodiment.

The variable capacitor may serve to adjust resonant frequency according to location variation of transmitting coil. At this time, the resonance frequency of the transmitting coil may be set as the same value as resonance frequency of receiving coil, and Q-factor (quality factor) may be set to be higher.

When a signal corresponding to intensity of transmission power is received from the transmission power determiner 140, the transmitter 160 may generate transmission power corresponding to the intensity of transmission power. At this time, the generated transmission power may be converted into a magnetic signal through the transmitting coil and be transmitted to the receiving device 200.

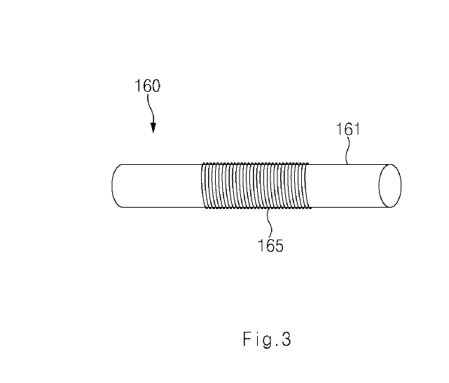

FIG. 3 is a diagram illustrating an example of a configuration of a transmitter of wireless power transmission apparatus according to an embodiment of the present disclosure.

The transmitter 160 shown in FIG. 3 illustrates an embodiment of implementing a ferrite in the form of rod, but the ferrite may be implemented in various forms according to embodiments. Here, as shown in FIG. 3, the transmitting coil 165 may be implemented in a form of being winded in a ferrite rod 161. At this time, when magnetism corresponding to transmission power is generated through the transmitting coil 165, the ferrite rod 161 may increase inductance of the transmitting coil 165 to improve transmission efficiency.

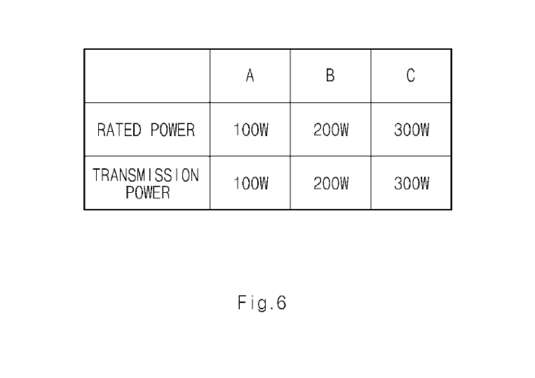

FIGS. 4A to 6 are diagrams illustrating an operation of wireless power transmission apparatus according to an exemplary embodiment of the present disclosure.

FIGS. 4A to 4C are diagrams illustrating embodiments of operation of varying location of transmitting coil of apparatus.

FIG. 4A illustrates that the transmitter 160 of the apparatus 100 is disposed farthest away from a receiver 210 of receiving device on a vertical line. In this case, the distance is L1. In the meantime, similar to FIG. 4A, FIG. 4B illustrates that the transmitter 160 moves toward the receiver 210 by a certain distance from a location in which the distance between the transmitter 160 and the receiver 210 is L1. In this case, the distance is L2. Further, similar to FIG. 4A, FIG. 4C illustrates that the transmitter 160 moves to the right by a certain distance from the location in which the distance between the transmitter 160 and the receiver 210 is L1 on a vertical line of the transmitter 160 and the receiver 210.

As described above, the distance between the transmitter 160 and the receiver 210 of FIG. 4A to FIG. 4C is different from each other such as L1, L2, and L3, respectively. As such, the mutual inductance between the transmitter 160 and the receiver 210 may differ. Further, the voltage ratio applied to receiving coil may also be changed by the transmitting coil in each location. In this case, when exceeding a certain distance, as the transmitting coil approaches the receiving coil, the difference of the voltage ratio becomes small, and thus power efficiency may be increased. However, when the transmitting coil and the receiving coil become closer than a certain distance, the difference of the voltage ratio is increased again, and thus power efficiency may be decreased.

Assuming that another receiving device is located, although the distance the transmitter 160 and the receiver 210 is the same as L1 as shown in FIG. 4A, if specification of corresponding apparatus is different from the above mentioned receiving device, the power efficiency according to voltage ratio change in a corresponding location may be varied as shown FIG. 5. In FIG. 5, receiving device A has high power efficiency within a short distance, whereas receiving device B has high power efficiency when distance is longer than A. Further, receiving device C has high power efficiency when distance is longer than B.

Accordingly, an apparatus may measure rated power in a location in which a difference of voltage ratio calculated for each distance with respect to the receiving device A, B, and C is minimized, i.e., a location in which power efficiency of receiving device A, B, and C is maximized, and may determine transmission power for the receiving device A, B, and C based on the measured rated power. In other words, the rated power of the receiving device A becomes 100 W in a location in which power efficiency according to distance between the apparatus and the receiving device A is maximized. Accordingly, the apparatus may determine transmission power for the receiving device A as 100 W.

Further, the rated power of the receiving device B becomes 200 W in a location in which power efficiency according to distance between the apparatus and the receiving device B is maximized. Accordingly, the apparatus may determine transmission power for the receiving device B as 200 W. The rated power of the receiving device C becomes 300 W in a location in which power efficiency according to distance between the apparatus and the receiving device C is maximized. Accordingly, the apparatus may determine transmission power for the receiving device C as 300 W.

As described above, transmission power may be determined in response to rated power of corresponding receiving device in a location in which difference of voltage ratio applied to receiving coil for each receiving device is minimized, such that transmission efficiency according to wireless power transmission may be increased, and a different type of receiving device may be available.

Hereinafter, the operation flow of wireless power transmission apparatus configured as described above according to the present disclosure is described in more detail.

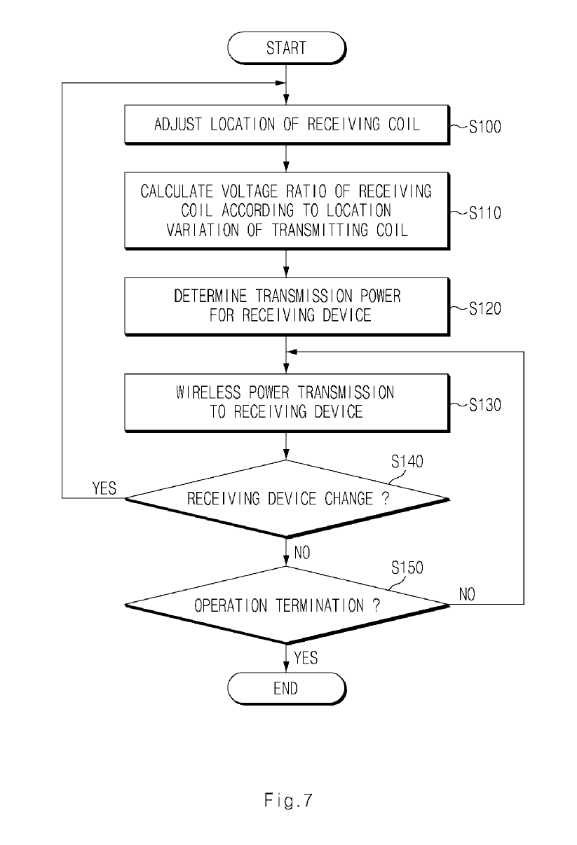

FIG. 7 is a flowchart illustrating an operation flow of wireless power transmission method according to an embodiment of the present disclosure.

As shown in FIG. 7, apparatus may adjust location of receiving coil to transmit wireless power to receiving device (S100). In this case, the apparatus may measure a voltage ratio applied to receiving coil of receiving device in each location according to location variation of the transmitting coil at step 100, e.g., a ratio of forward voltage into receiving coil and reflect voltage from receiving coil (S110), and may determine transmission power for corresponding receiving device on the basis of the voltage ratio calculated at step 110 (S120). In other words, the apparatus may measure the rated power of the receiving device based on a location in which a difference of the voltage ratio is minimized among voltage ratios applied to the receiving coil according to location of transmitting coil, and determine the above measured rated power of receiving device as transmission power for a corresponding receiving device.

When the transmission power for receiving device is determined at step 120, the apparatus may perform wireless power transmission according to the determined transmission power (S130). The step 130 may be performed until the receiving device is changed (S140), or until a command of operation termination of corresponding apparatus is entered (S150). Further, if the receiving device is changed at step 140, the operation is repeated from step 140, and if a command of operation termination is entered at step 150, the operation of wireless power transmission of corresponding apparatus is terminated.

Although exemplary embodiments of the present disclosure have been described in detail hereinabove, it should be clearly understood that many variations and modifications of the basic inventive concepts herein taught which may appear to those skilled in the present art will still fall within the spirit and scope of the present disclosure, as defined in the appended claims.

What is claimed is:

1. A wireless power transmission apparatus, comprising:
a transmitter to generate transmission power to a receiving coil of a receiving device through a transmitting coil;
a location adjuster to adjust a location of the transmitter based on a location of the receiving coil;
a voltage ratio calculator to calculate a voltage ratio applied to the receiving coil according to a location variation of the transmitter; and
a transmission power determiner to determine an intensity of the transmission power for a signal output to the receiving device resulting from the voltage ratio applied to the receiving coil, and to transmit a signal corresponding to the intensity of the transmission power to the transmitter.

2. The wireless power transmission apparatus of claim 1, wherein the voltage ratio calculator calculates a ratio of a forward voltage of the receiving coil and a reflect voltage based on a variation of mutual inductance of the transmitting coil according to the location variation of the transmitter.

3. The wireless power transmission apparatus of claim 2, wherein the transmission power determiner measures rated power of the receiving device in a location in which a difference between the forward voltage and the reflect voltage is minimized according to the location variation of the transmitter.

4. The wireless power transmission apparatus of claim 3, wherein the transmission power determiner determines the rated power of the receiving device as transmission power of the transmitting coil.

5. The wireless power transmission apparatus of claim 1, wherein the location adjuster adjusts the location of the transmitter by a predetermined distance unit based on at least one direction among front, rear, left, right, up, down, and diagonal directions.

6. The wireless power transmission apparatus of claim 1, wherein the location adjuster adjusts the location of the transmitter from a long distance to a short distance based on the location of the receiving coil.

7. A wireless power transmission method, comprising:
adjusting a location of a transmitting coil based on a location of a receiving coil for a receiving device;
calculating a voltage ratio applied to the receiving coil according to a location variation of the transmitting coil;
determining an intensity of transmission power for a signal output to the receiving device resulting from the voltage ratio applied to the receiving coil; and
generating transmission power corresponding to the determined intensity of the transmission power from the transmitting coil to the receiving coil.

8. The wireless power transmission method of claim 7, wherein the calculating of the voltage ratio comprises calculating a ratio of a forward voltage of the receiving coil and a reflect voltage based on a variation of mutual inductance of the transmitting coil according to the location variation of the transmitting coil.

9. The wireless power transmission method of claim 8, further comprising measuring rated power of the receiving device in a location in which a difference between the forward voltage and the reflect voltage is minimized according to the location variation of the transmitting coil.

10. The wireless power transmission method of claim 9, wherein the determining of the intensity of the transmission power comprises determining the rated power of the receiving device as transmission power of the transmitting coil.

11. The wireless power transmission method of claim 7, wherein the adjusting of the location of the transmitting coil comprises adjusting the location of the transmitting coil by a predetermined distance unit based on at least one direction among front, rear, left, right, up, down, and diagonal directions.

12. The wireless power transmission method of claim 7, wherein the adjusting of the location of the transmitting coil comprises adjusting the location of the transmitting coil from a long distance to a short distance based on the location of the receiving coil.
